(19) United States
(12) Patent Application Publication
(10) Pub. No.: US 2015/0136769 A1
(43) Pub. Date: May 21, 2015

(54) MICROWAVE PRESSURE COOKER

(71) Applicant: Meyer Intellectual Properties Ltd., Kowloon (HK)

(72) Inventors: Jason Quinn, TOKYO (JP); Yumi Nukuda, Tokyo (JP)

(21) Appl. No.: 14/548,994

(22) Filed: Nov. 20, 2014

Related U.S. Application Data
(60) Provisional application No. 61/907,297, filed on Nov. 21, 2013.
(60) Provisional application No. 62/079,740, filed on Nov. 14, 2014.

(51) Int. Cl. A47J 27/09; B65D 81/34; B65D 51/16; A47J 36/10

(52) U.S. Cl. CPC A47J 27/09; A47J 36/10; B65D 81/3453; B65D 51/16
USPC 220/203.01; 220/315; 220/240

(57) ABSTRACT

A chamber formed of a dielectric material is sealed with a lid for use in a microwave oven. The lid contains a pair of translating grip that engage the chamber rim to seal the vessel to contain pressure. The grips can be activated to release the lid by a centrally disposed button type actuator. The grips are coupled to a vent release means formed within the shell like construction of the lid.

### CROSS REFERENCE TO RELATED APPLICATIONS

The present application claims the benefit of priority to the US Provisional Patent Application of the same title that was filed on Nov. 21, 2013, having application Ser. No. 61/907,297, which is incorporated herein by reference. This application also claims the benefit of priority the US Provisional Patent Application of the same title that was filed on Nov. 14, 2014, having application Ser. No. 62/079,297, which is incorporated herein by reference.

### BACKGROUND OF INVENTION

The present invention relates pressure cookers, and more particularly to microwave pressure cookers.

Prior microwave pressure cookers devices may be difficult for some consumers to use properly, that is to properly insert and remove the lid after cooking and venting any pressurize steam remaining therein.

It is therefore an object of the present invention to provide a microwave pressure cooker formed entirely of dielectric materials, such as plastic and rubber/elastomers.

It is another object of the invention to provide a microwave pressure cooker that is easier to seal with the lid and vent.

It is another object of the invention to provide a microwave pressure cooker in which it is readily apparent that it is pressurized, and that it is easy to vent the pressure safely.

It is another object of the invention to provide a microwave pressure cooker that cannot be opened when pressurized due to lid engaging safety measures.

It is another object of the invention to provide a microwave pressure cooker cannot be pressured unless the safety measures are capable of engagement.

### SUMMARY OF INVENTION

In the present invention, the first object is achieved by providing a is characterized a pressure containing chamber comprising a vessel having an upper rim with a flange portion, a lid for sealing the vessel, a resilient sealing means disposed between the lid and the upper rim, a pair of arc shaped laterally translating grips that have a lower surface for grasping the flange portion of the vessel to urge the lid in sealed engagement with the vessel by compressing the resilient sealing means, an actuator disposed in the center of the lid that is operative to move to an upper vertical direction position to displaying a pressurized state of the vessel in which urging the said actuator to a lower vertical laterally displaces the translating grips from the position urging the lid in sealed engagement with the vessel by compressing the resilient sealing means.

A second aspect of the invention is characterized by a vessel with an upper rim, a lid for sealing the vessel at the rim thereof, and defining an interior volume between an interior of the vessel and a lower surface of the lid, the lid having, a upper portion with a central aperture that accommodates a central actuator and a peripheral aperture that accommodates a secondary actuator, in which the peripheral aperture is outside of the central aperture, a lower portion having an annular lower flange for engaging a gasket, wherein an open cavity is formed between the upper portion and the lower portion, a channel defined by a vertical wall connecting the peripheral aperture with one or more penetration in the lower portion of the lid, a first valve sealing the one or more penetrations in the lower lid within the channel, wherein said secondary actuator is operative to open said first valve and equalize pressure between the interior volume and the exterior of the vessel.

Another aspect of the invention is characterized by the pressure containing chamber wherein the actuator is a button disposed in the center of the lid to be flush with an upper surface thereof when the vessel is not pressurized.

Another aspect of the invention is characterized by the pressure containing chamber further comprising a latching means that is operative to lock the grips when the vessel is under pressure.

Another aspect of the invention is characterized in that the latching means is a first vent means that remains open until the arc shaped laterally translating grips urge the lid in sealed engagement with the vessel by compressing the resilient sealing means.

Another aspect of the invention is characterized in that the chamber comprises a vent well in the lid disposed outside of a vertical channel therein that receives the actuator.

Another aspect of the invention is characterized in that the first vent means is disposed in the vent well.

Another aspect of the invention is characterized in that the chamber further comprises a second vent means that is disposed in the vent well.

Another aspect of the invention is characterized in that the chamber further comprises a vent well cover that operative to actuator the second vent means.

Another aspect of the invention is characterized in that the a vent well cover is actuated on a first end to open the second vent means by toggling from a horizontal orientation to a tilted orientation.

Another aspect of the invention is characterized in that the vent well cover comprises one or more vent holes proximal to second end opposite the first end.

Another aspect of the invention is characterized in that the chamber further comprises pressure regulating diaphragm in the vent well.

Another aspect of the invention is characterized in that the chamber further comprises an over pressure relief valve in the vent well that is operative to vent at a pressure beyond the nominal maximum operating pressure of the pressure regulating diaphragm remains

Another aspect of the invention is characterized in that the secondary actuator is a cover of the peripheral aperture.

Another aspect of the invention is characterized in that the chamber further comprises a first pressure regulator sealing a penetration in the lower lid within the channel.

Another aspect of the invention is characterized in that the chamber further comprises an over pressure valve sealing a penetration in the lower lid within the channel, where the pressure regulator is operative to regulate pressure to a first pressure level and the over pressure valve is operative to open and equalize pressure between the interior volume and the exterior of the vessel at a second pressure level above the first pressure value.

Another aspect of the invention is characterized in that the chamber further comprises a cover of the peripheral aperture defines an interior volume of the channel having a second value and the interior volume of the vessel has a first volume in which the first value is more than 0.1% of the second value.

Another aspect of the invention is characterized in that the chamber further comprises a cover of the peripheral aperture defines an interior volume of the channel having a second value and the interior volume of the vessel has a first volume in which the first value is more than 0.2% of the second value.

Another aspect of the invention is characterized in that the chamber further comprises a cover of the peripheral aperture defines an interior volume of the channel having a second value and the interior volume of the vessel has a first volume in which the first value is more than 0.5% of the second value.

Another aspect of the invention is characterized in that the central actuator disposed in the center of the lid that is operative to move to an upper vertical direction position to displaying a pressurized state of the vessel in which urging the said actuator to a lower vertical laterally disengages the lid for lifting from the rim of the vessel.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a perspective view of a first embodiment of the microwave pressure cookers device

FIG. 2 is a top plan view of the microwave pressure cookers device shown in FIG. 1

FIG. 3 is a top plan view of the microwave pressure cookers device shown in FIG. 1 with the lid grips in the open position.

FIG. 4A is a side elevation view of the microwave pressure cookers device shown in FIG. 1, whereas FIG. 4B is front elevation view thereof.

FIG. 5 is a bottom plan view of the microwave pressure cookers device shown in FIG. 1.

FIG. 6 is exploded view of the microwave pressure cookers device shown in FIG. 1.

FIG. 7 is a cross-sectional elevation of the microwave pressure cookers device shown in FIG. 1, taken at section line A-A in FIG. 2.

FIG. 8A is a partial top perspective view of the vent components disposed in the bottom lid and the underside of the vent well cover, where FIG. 8B is a top plan view of the vent well cover and FIG. 8C is a cross-sectional elevation thereof.

FIG. 9 is a cross-sectional elevation view of another embodiment of the microwave pressure cookers device to illustrate alternative positions of the central actuator.

FIG. 10A-C are cross-sectional elevations to illustrate three alternative position of 240 as modified by gasket 260 during use in which FIG. 10A shows the central actuator position when the vessel is pressurized, FIG. 10B shows the unpressurized condition and FIG. 10C shows the 240 depressed to release the side grips that engage the rim.

FIG. 11A is another partial bottom perspective view of the vent components disposed in the bottom lid with the top lid removed, whereas FIG. 11B is a perspective view of the pressure sensitive stopper.

FIG. 12A is a full perspective view from above a translating grip member and the rocker member that connects both translating grip members, whereas FIG. 12B and FIG. 12C are a top plan view and side elevation view of the rocker member respectively.

FIG. 13 is a partial exploded view of the lid in an alternative embodiment of the invention.

FIG. 14A is a cross-sectional elevation of the lid in the embodiment of FIG. 13; FIG. 14B is an enlarged orthogonal cross-sectional elevation of the circled portion in FIG. 14A and FIG. 14C is a plan cross section view of FIG. 14B at section line C-C, in which section lines A-A indicates the orientation of the section view in FIG. 14A.

### DETAILED DESCRIPTION

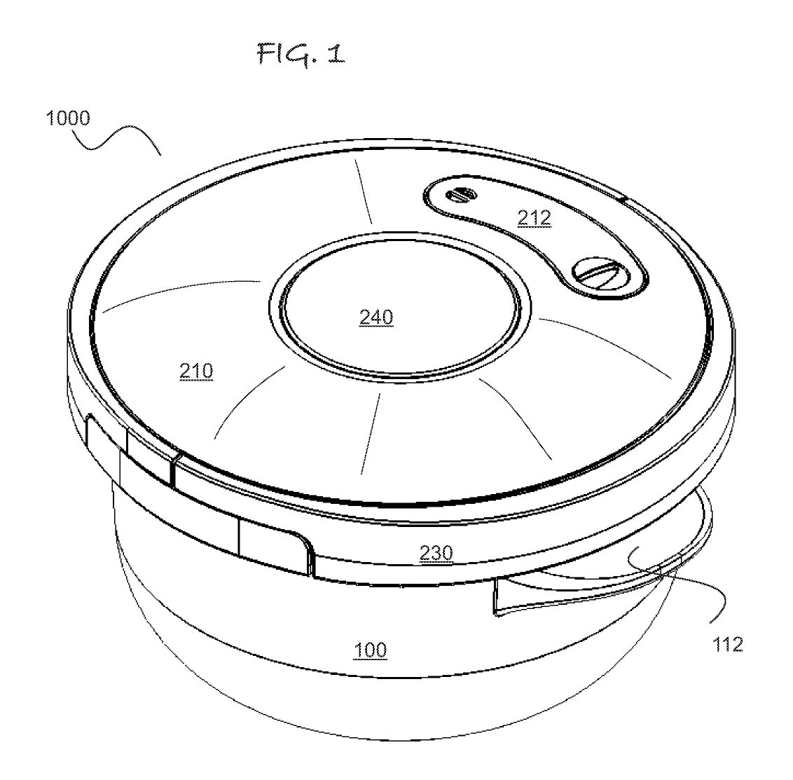

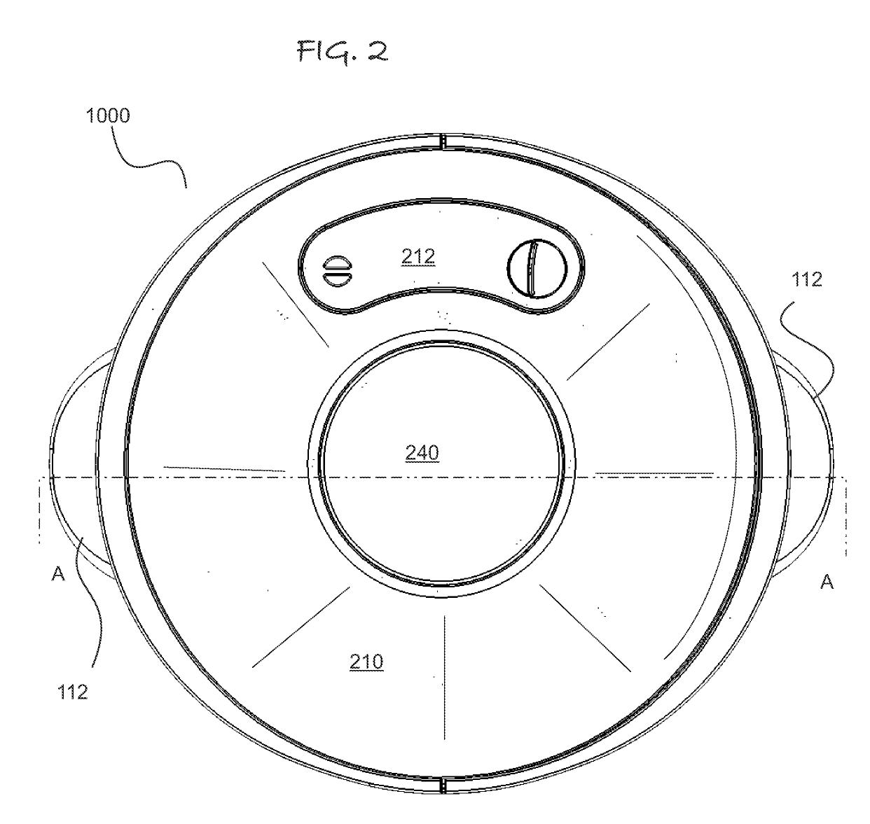

Referring to FIGS. 1 through 14, wherein like reference numerals refer to like components in the various views, there is illustrated therein a new and improved Microwave Pressure Cooker, generally denominated 1000 herein.

In accordance with the present invention a microwave pressure cookers device 1000 comprises a vessel 100 covered by a lid assembly 200, which sealingly that engages the rim 110 of the vessel 100 via an intermediary annular gasket 150.

The lid assembly 200 is essentially a shell formed of a top lid 210 that is connected to a bottom lid 220 by a plurality of interlocking pins and pin receiving standoffs, but can optionally deploy snaps and push or screw members, including plastic screws and push type screws. A bottom lid 220 preferably receives the annular rim sealing gasket 150 on a lower surface. The grips 230 and 230′ are arc shaped to present a relatively long engaging surface 231 below the vessel rim 110. The vessel 100 also preferably deploys integrated sideward extending handles 112 below rim 110.

The bottom lid 220 preferably comprises multiple pressure relief means, which are preferably formed in a vent well 221 covering different aperture formed in the bottom of the well 221. The vent well 221 preferably has a kidney shape, which increases the interior volume in the area around the central actuator 240. The vent well is a conduit in the upper portion of the bottom lid 220 to the upper lid 210 defined by vertical walls 2211 Pressure relief means within the vent well 221 are preferably actuated by a vent well cover 212. The vent well cover 212 fills an aperture 211 formed in the upper surface of the top lid 210.

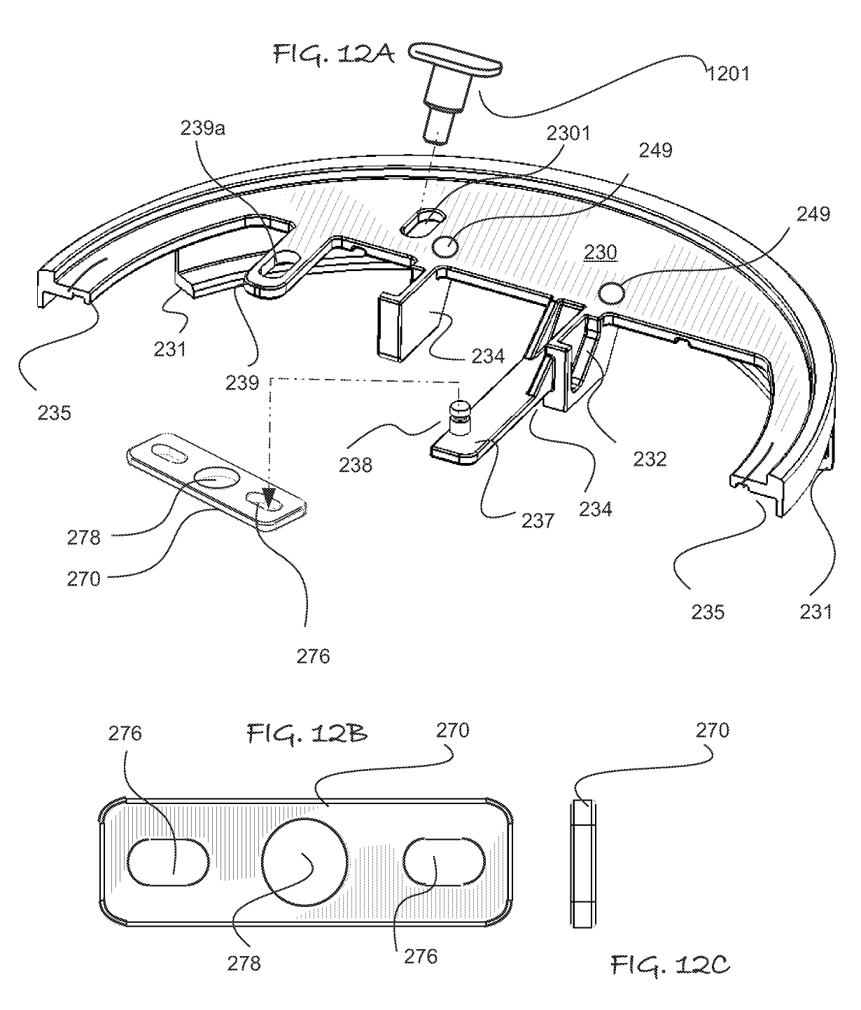

In the embodiment of FIG. 1-14, the vessel 100 is sealed for cooking by a pair of laterally translating locking handle or grips 230 and 230′, which are jaw or arc shaped and have a lower edge 231 which engages the underside of the rim extending flange 115. The translating grips 230 are coupled to a central actuator button 240 on the lid 200. The vent well 221 and vent well cover 212 are disposed outside the central actuator button 240. When the microwave pressure cooker is covered by the lid 200 and ready for use, translating grips 230 and 230′ are moved fully inwards. As shown in FIG. 12, each grip 230 is secured to slide over the bottom lid 220 by a retainer 1201 with a flat flange top and cylindrical bottom that enters an aperture 2301 in the top of the grip 230 so the cylindrical bottom can attached to an the lower lid 220. The attachment can be by a screw, compression fit or welded connection and the like to the bottom lid 220.

The pair of translating grips 230 are coupled to a central actuator button 240 that extends upward through an inner central aperture 214 within the top lid 210. Thus after cooking, the user can depress the central actuator button 240 to urge the translating grips 230 outward away from each other. The coupling means between the central actuator button 240 and the translating grips 230 and 230′ is controlled by one or more pressure sensitive latch means that precludes opening the cooker 1000 and removing the lid 200 until the internal pressure is reduced in the vessel 100 after cooking. The latch means engage a portion of the translating grips 230 and 230 only when they are fully moved inward. The latch means, if not properly engaged by the grips 230 and 230′ also precludes pressurization of the vessel. Likewise, once the vessel 100 is pressurized, the grips 230 and 230′ cannot be moved apart until the vessel 100 is vented of the pressure.

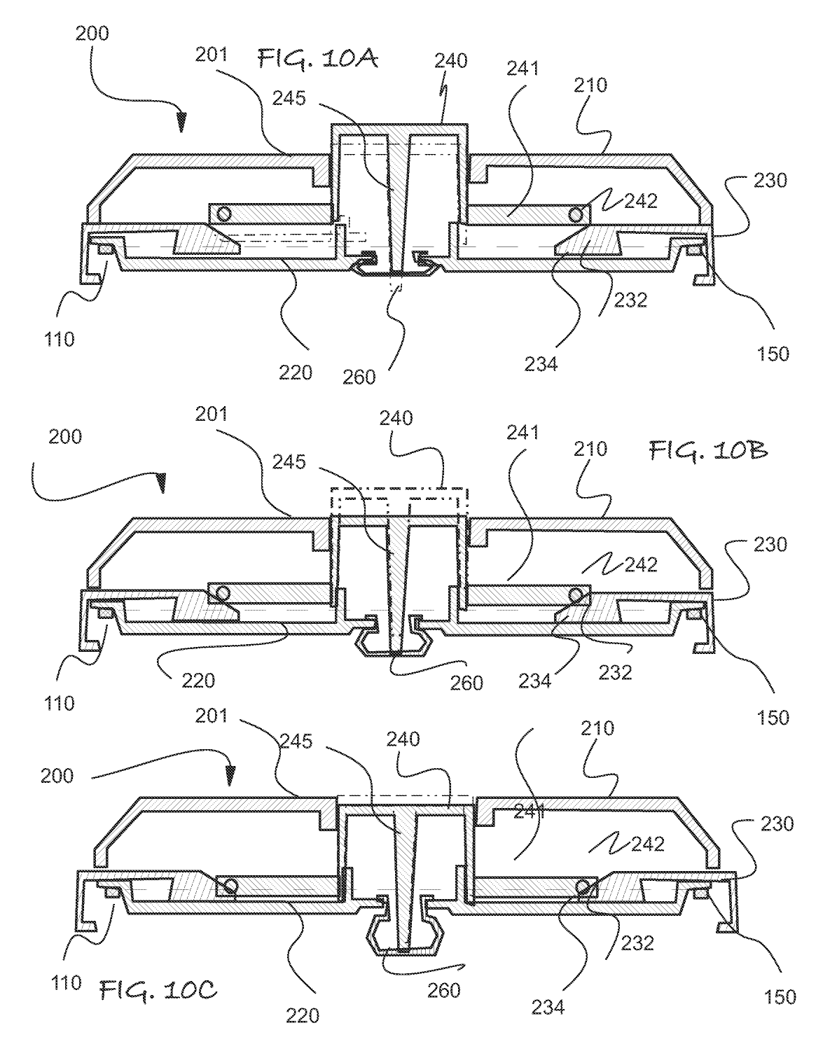

After cooking, pressure reduction occurs slowly on the simply cooling of steam and condensation to form water. The central button 240 is coupled to an interior of the vessel by a spring member, which in the case of intended microwave use, is preferably a resilient rubber or elastomeric bellows 260. As shown in FIG. 10A, when the vessel 100 is pressurized the central button 240 rises above the adjacent portion 201 of the lid 200. When the vessel 100 is not pressurized (FIG. 10B), the central button 240 preferably falls to become flush with the adjacent portion 201 of the lid 200, as the bellows 260 is no longer compressed to urge the central downward extending inner cylinder 245 upward. This indicates that the translating grips 230 and 230 can be or moved outward from each other apart so the lid 200 can be lifted off the vessel (FIG. 10C). This is accomplished by depressing the central button 240, which extends the bellows 260 from the equilibrium shape.

The vessel 100 is optionally vented using the vent well cover 212 as a valve actuator. Then, depressing the central actuator 240 below the adjacent portion of the lid 201 moves the grips 230 in opposing directs to unlock the lid. The elastomeric bellows 260 opposes such movement by urging the central downward extending inner cylinder 245 upward.

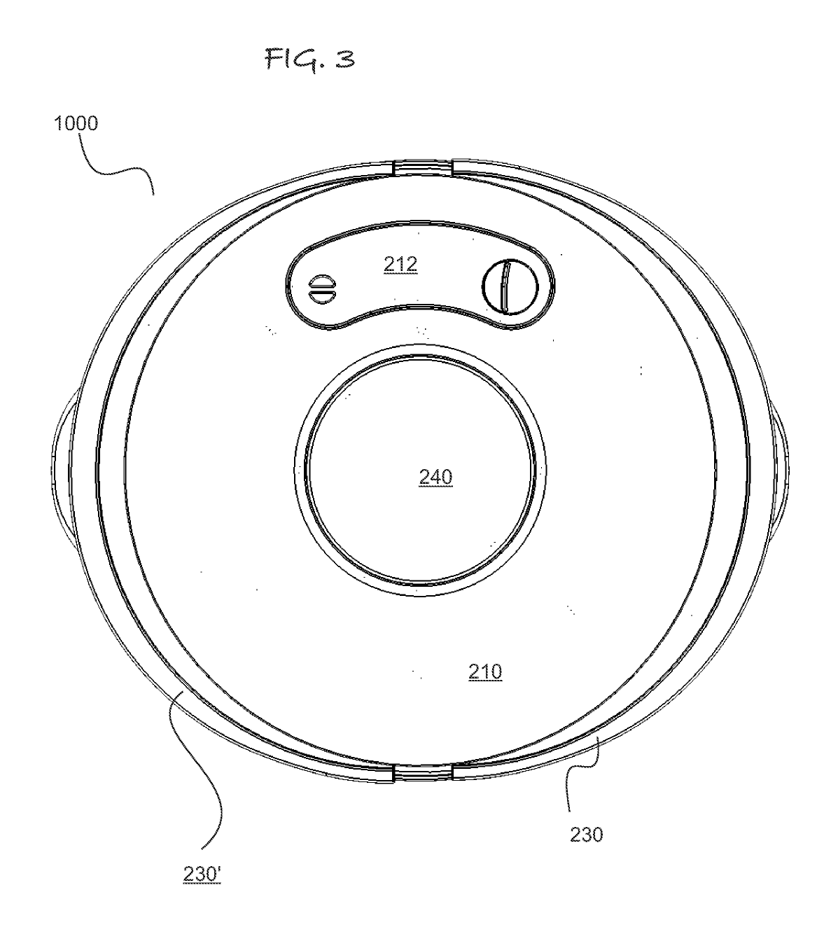

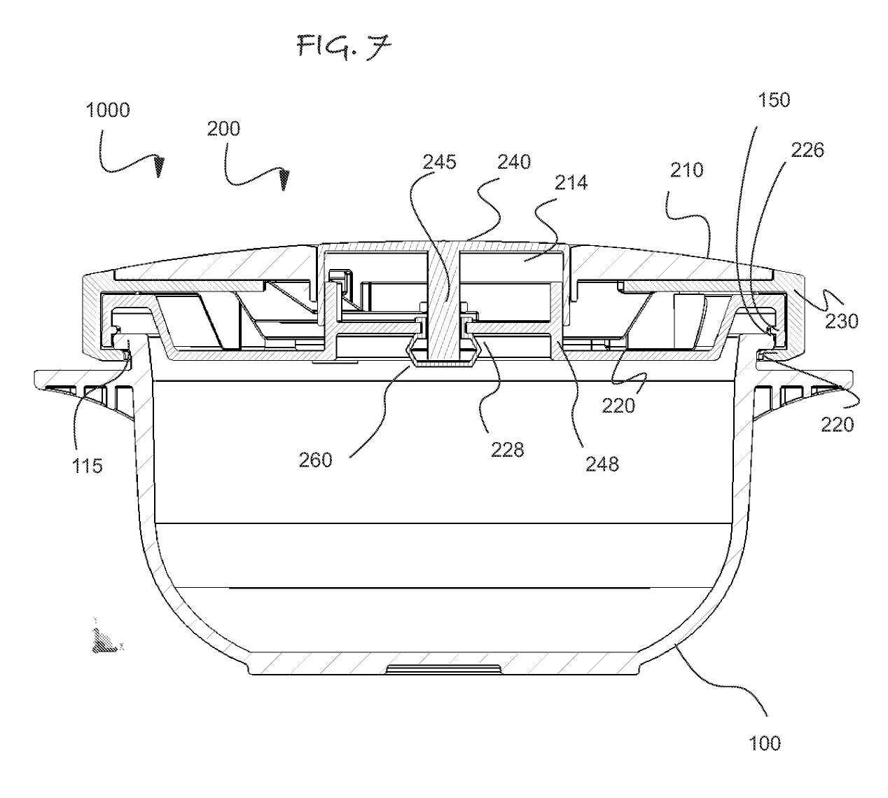

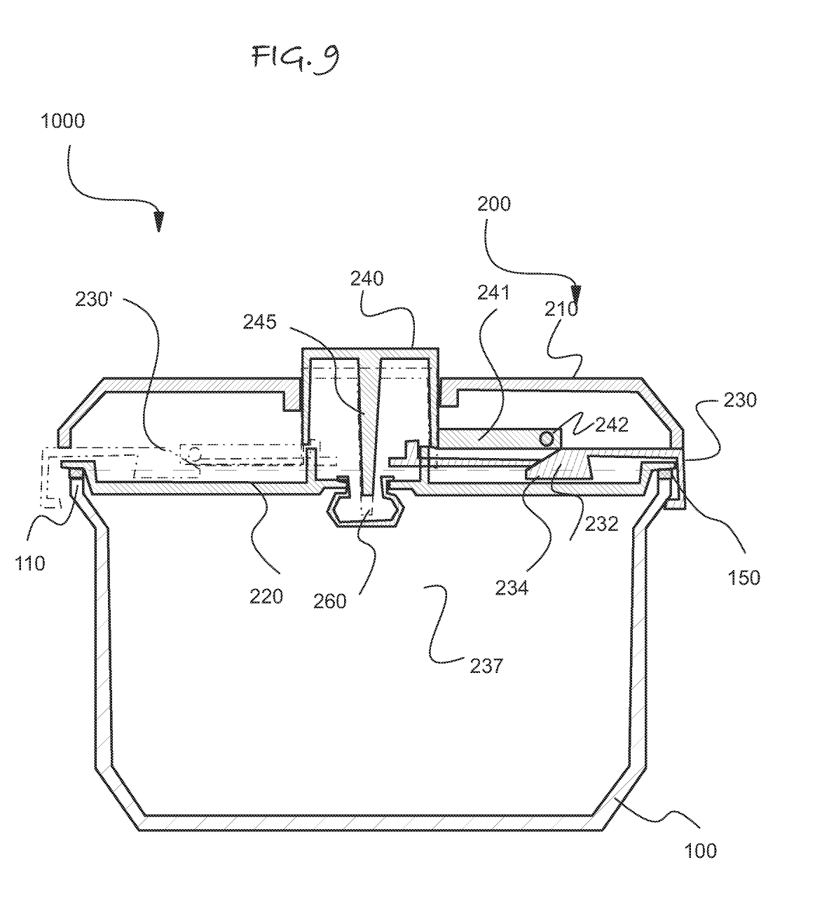

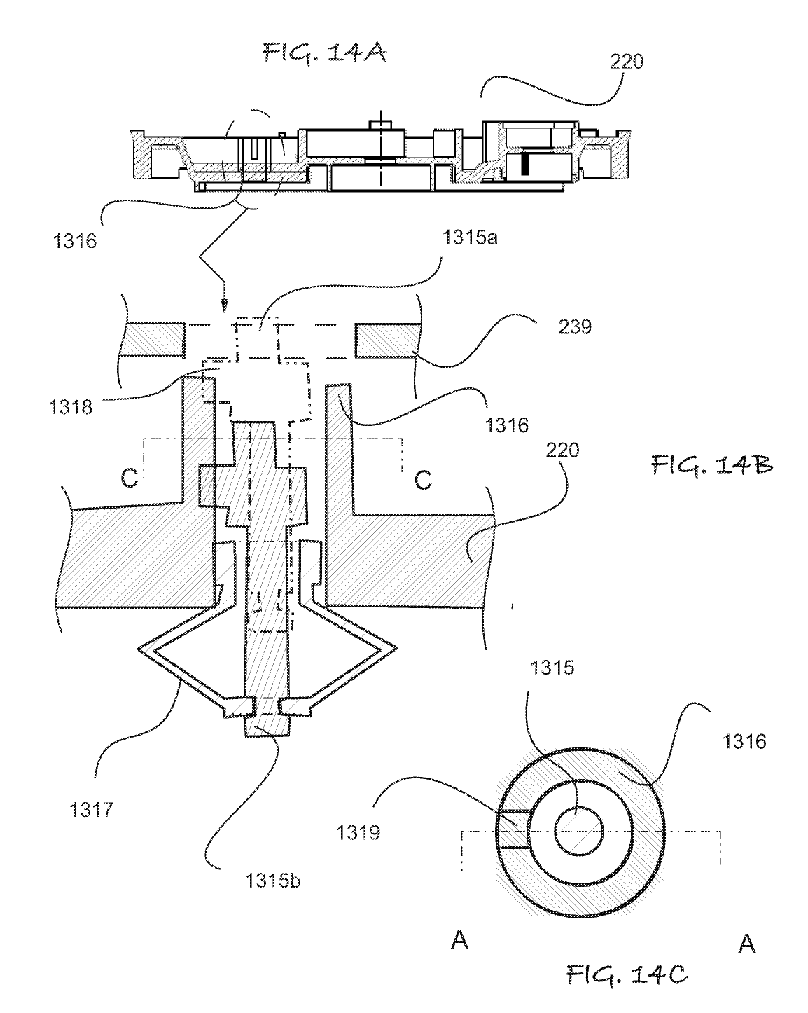

To seal the vessel 100 for pressurization during microwave cooking a wedge interference fit between at least a portion of the bottom lid 220 and the underside of the grip 230 forces an inner annular flange 226 on the bottom lid against at least a portion of the rim 110 or rim extending flange, compressing any resilient sealing member or gasket disposed between these surface, which is generally indicated by reference no. 150. Alternatively, the vessel 100 can have a horizontal lower flange with is engaged by a wedge or ramp shaped portion of the lower edge 231 of the translating grip 230. The laterally translating grips 230 have a general arc shape at the lower edge 231 (FIG. 14) but a U shaped orthogonal cross section (FIGS. 7 and 9) to present a wider upper shell like portion that slides within a gap formed between the bottom lid 220 and the top lid 210. The alternative or open position of the grips 230 are shown in FIG. 3 and the left side of FIG. 9 with phantom lines. It should be noted, in a preferred embodiment, the vessel 100 can be sealed at any rotation of the lid 200 about the vertical central axis of the vessel 100.

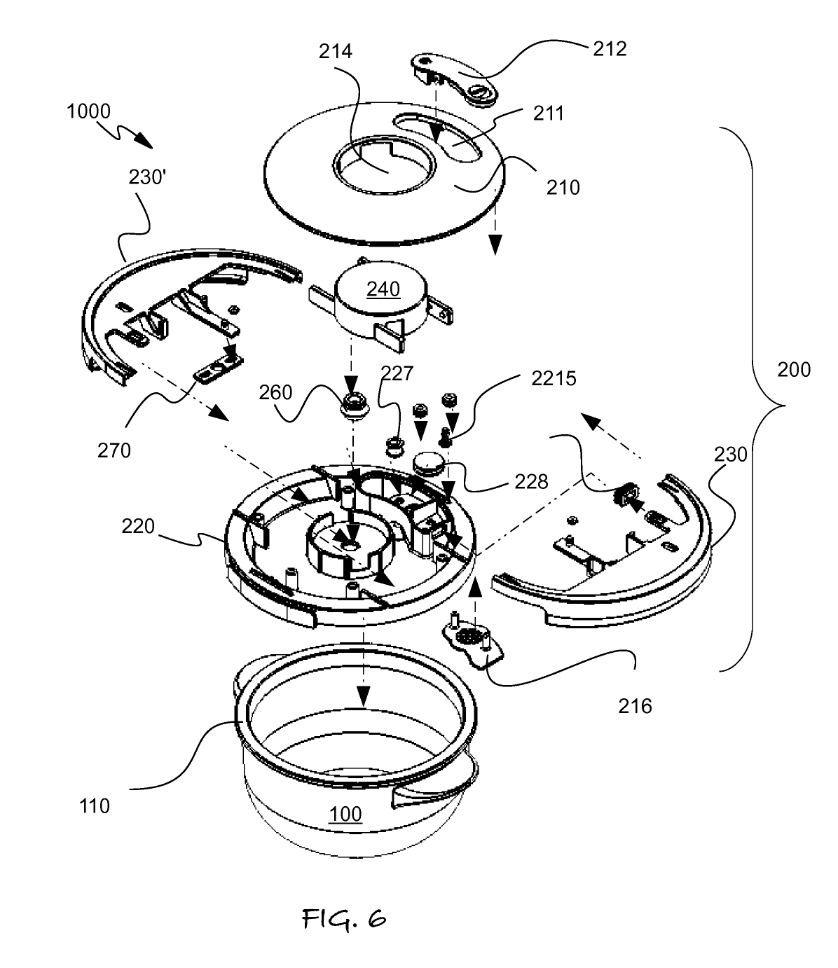

As shown in FIGS. 6, 8 and 11, one embodiment of the latch means that engages one of the laterally translating grips 230 is pressure sensitive stopper 2215. At least one, but preferably both of the laterally translating grips 230 and 230′ has a forward actuating member 239 that is operative to engage the pressure sensitive stopper 2215 within the vent well 221.

The forward actuating arm 239 is an inward extension of the grip 230 that has an aperture that receives a pressure sensitive stopper 2215. The pressure sensitive stopper 2215 is configured to rise upward a hole in the bottom lid 220 to enter the aperture 239a in the forward actuating arm 239. The stopper 2215 has a flat bottom flange 2215f below the lower lid 220 to urge a surrounding annular gasket to seal against the downward face of the lower lid so the vessel can become pressurized with steam. The stopper also preferably has a non-circular cross-section, such as fluted sides above the flange 2215f for fitting in a “+” shaped vertical hole in the bottom lid. The non-circular hole provides guided lifting under pressure in the vessel 100, whereas an annular rim 2215r in the fluted portion precludes the stopper from dropping through the vertical hole If the vessel 100 is pressurized, the stopper 2215 will be in an upper position, entering the aperture 239a in the forward actuating member 239 and preventing outward movement of grips 230 and 230′, thus precluding the removal of the lid 200 until the vessel is vented of pressure. However, if the grip 230 is not fully inserted, the stopper 2215 will hit the underside of the forward actuating member 230 and not enter the aperture therein so the hole or bore in the lower lid 220 will remain open. Hence. The vessel 100 cannot be pressurized unless the grips 230 and 230′ are the position in which latching under pressure will occur.

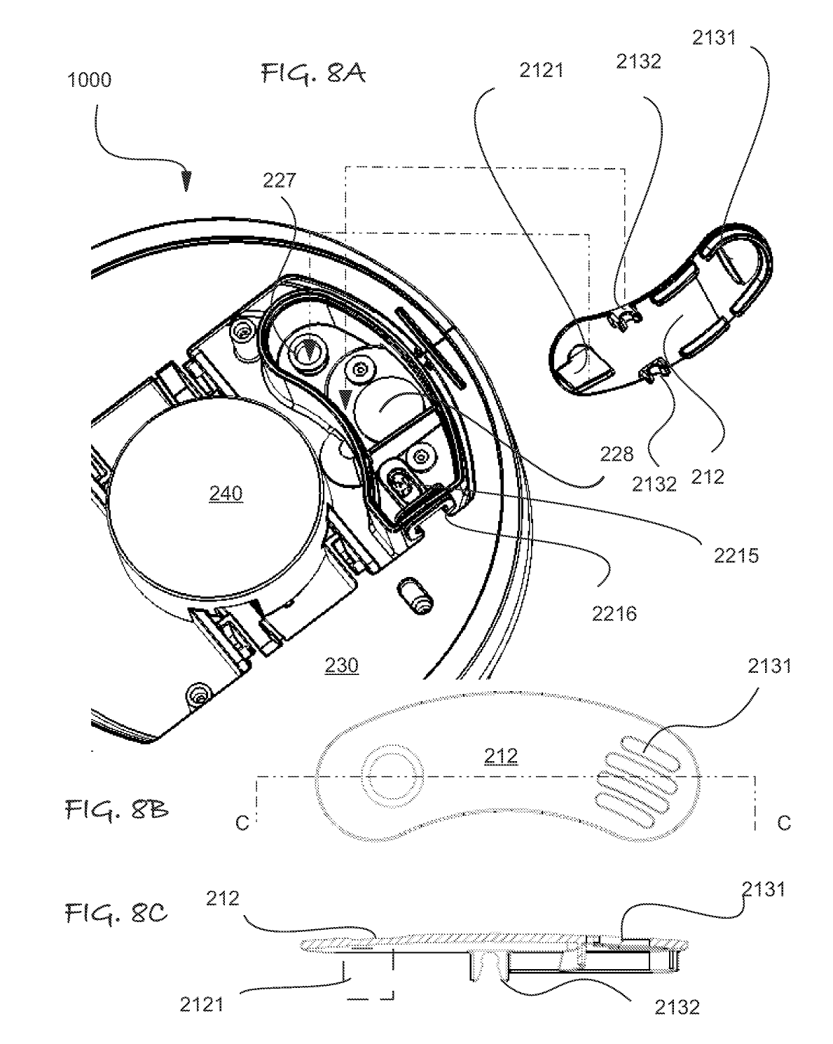

After cooking is completed, either on cooling or when a vent meant is manually opened, the stopper 2215 will fall, allowing the forward actuating member 239 and the grips 230 and 230′ to translate to in opposite directions, that is outward so the lid 200 can be removed. Such a preferred embodiment deploys the vent well cover 212 as a toggle switch to open a vent means or slit diaphragm 227 in the vent well 221. The lower surface of the vent well cover 212 has downward extending plate 2121 that can deform and open diaphragm 227, or otherwise displace it to open the aperture it would otherwise seal under pressure. The vent well 221 also houses at least one pressure regulating diaphragm 228. The surface of the vent well cover 212 has penetration, such as slits or holes and the like, 2131 distal from the portion over the downward descending plate 2121 so steam is vented away from the user's hand only after first diffusing to a lower pressure within the vent well 221. The toggle supports 2132 on the lower surface of the vent well cover 2132 (shown pointing upward in FIG. 8), have notches which engage cylindrical pillars extending laterally inward from just below the inner rim of the perimeter of the vent well opening 211 in the upper lid 210. The toggle supports 2132 are disposed between the vent holes and the downward extending plate 2121. It should be appreciated that the positions of the toggles supports and inward cylinders can be reversed. The notches provide a snap fitting for ease of removal to access and clean the vent well area and the cover. The volume of the vent well is preferably at least 0.1% of the vessel volume to allow the steam to expand, reducing the temperature and velocity before it exits the penetration in the 2131 in the vent well cover 212. The volume of the vent well is more preferably at least 0.2% of the vessel volume, but most preferably at least 0.3%. It should be appreciated the preferred range of volume may vary with the size, shape, placement and number of the penetrations 2131 in the vent well cover.

The bottom of the pressure regulating diaphragm 228 is covered by a screen 216 to prevent food debris from forming clogs. A screen 216 can optionally cover any aperture in the lower lid used for venting to prevent clogging by food debris. The screen is preferably on a detachable plate that snaps into the lower portion of the vent well from the vessel side.

The vent and/or pressure relief/control means provided within the vent well 221 contemplates the slit dependent rubber gaskets, such as those disclosed in U.S. Pat. No. 8,247,751, which issued on Aug. 21, 2012, which is incorporated herein by reference. The pressure regulating diaphragm 228 is preferably a gasket with a central annular exterior recess or receiving the rim of the opening ion the vent well. Such a gasket is also preferably resilient rubber or elastic having a least one sealing surface within the annulus that is at least partially slit. The partial slit self closes due to the resilience of the rubber, but that opens when a pressure threshold is reached, venting steam until the pressure drops and the slit closes from the elastic restoring force in the rubber member. The slit diaphragm 227 can be configured to be fully expelled if the pressure regulating diaphragm 228 should be clogged. In addition to the slit diaphragm 227 there is preferably a second pressure regulating diaphragm, of similar construction should the primary regulator 228 fails or clog. The second pressure regulating diaphragm can have a similar structure, but is set in a smaller bore opening, and/or deploys thicker rubber at the slit so that it opens at a higher pressure than pressure regulating diaphragm 228. Any of the gasket type valves or pressure regulators can also be configured with thin or thick walls above the central annular recess (that engages the rim of the bore or penetration in the bottom of the vent well). Then excess pressure, should the slits in the gasket fail to open, can cause the thinner walls to deform, disengaging the gasket from the rim fo the aperture. Hence, in a preferred embodiment, the slit in the first gasket that provide the primary pressure regulation opens at a first pressure, the intended cooking pressure, the slit in the second gasket opens at second pressure higher than the first pressure, and the second gasket is ejected from the aperture it closes at a third pressure higher than the second pressure.

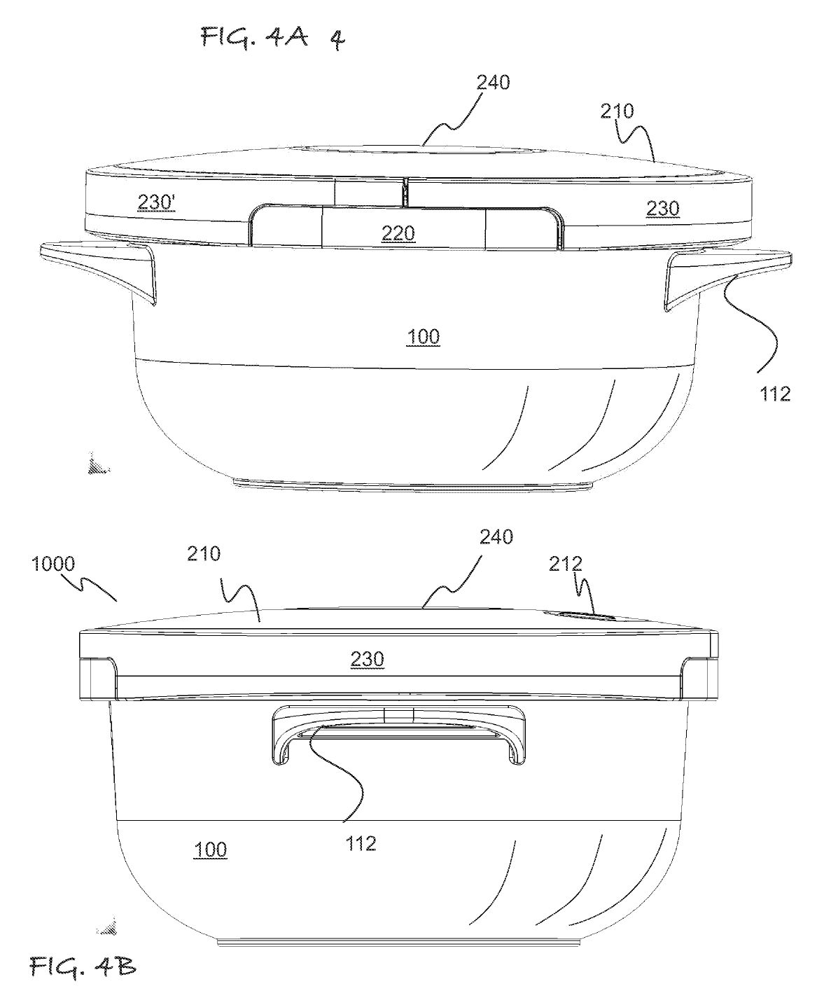

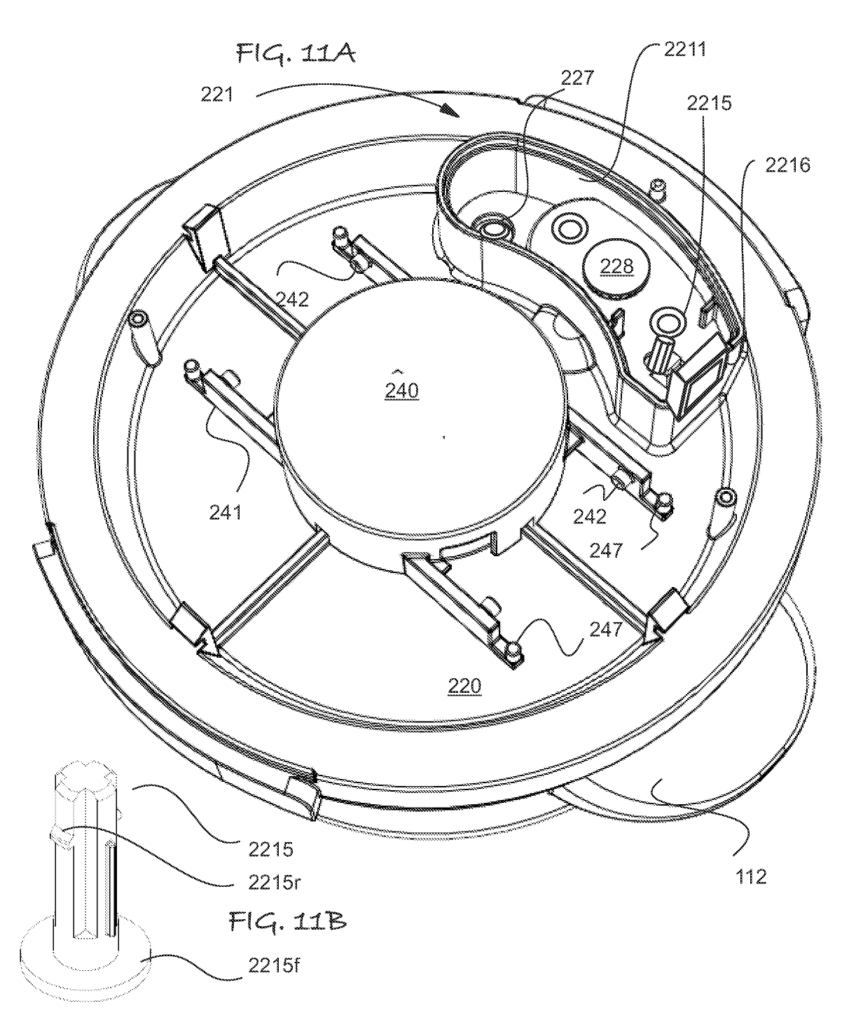

The vent well 221 also preferably contains at least one latch means to restrain the movement of grips when the vessel is under pressure. A generally rectangular ring gasket 2216 covers another aperture formed in the vent well wall 2211 to allow the sealed passage of the latch arm 239 that is laterally translated by the proximal grip 230 shown in FIGS. 4 and 11.

The forward actuating member 239 can either open or close a vent valve, or provide a means to restrain the rearward movement of the grips to prevent venting when the contents of the vessel are pressurized.

The left side of FIG. 9 shows the grip 230′ in the open position that permits lid 220 removal, with central actuator 240′ latched in the downward position, whereas the right side show the grip 230 in the locked position in which the bottom lid 220 compresses the annular gasket 150.

In a preferred embodiment of the invention, a spring member 260 formed of a rubber sealing bellows that covers and seals central aperture 228 in the bottom lid cover 220, and thus opposes the downward translation of the central actuator button 240 at the central downward extending inner cylinder 245.

The central actuator 240 has four lower arms 241 with inward oriented horizontal pins 242. A pins 243 on each side of the actuator 240 engages a ramped flange 232 (FIG. 12A) on an inner arm 234 of the grip 23o. Hence, the downward vertical movement of the central actuator 240 will cause the pins 234 to engage the ramped flanges 233 to push the grips 230 and 230′ laterally apart. The four arms 241 of the central actuator 240 also terminate in upward oriented cylinders 247 which engage the grips 230 in corresponding apertures 249 in portion of the grips 230 and 230′ behind the ramped portion 232 Hence, when the central actuator 240 is urged up by bellows 260, the alignment of the upward cylinders 247 in the apertures 249 maintains the contact of the horizontal pins 242 and ramped flange 233 surfaces.

In the case of an all plastic construction for microwave oven use, the U shaped section of the arm 241, cylinders and pin provides extra rigidity to preclude plastic deflection or distortion which would thwart the cooperate movement of the components described above.

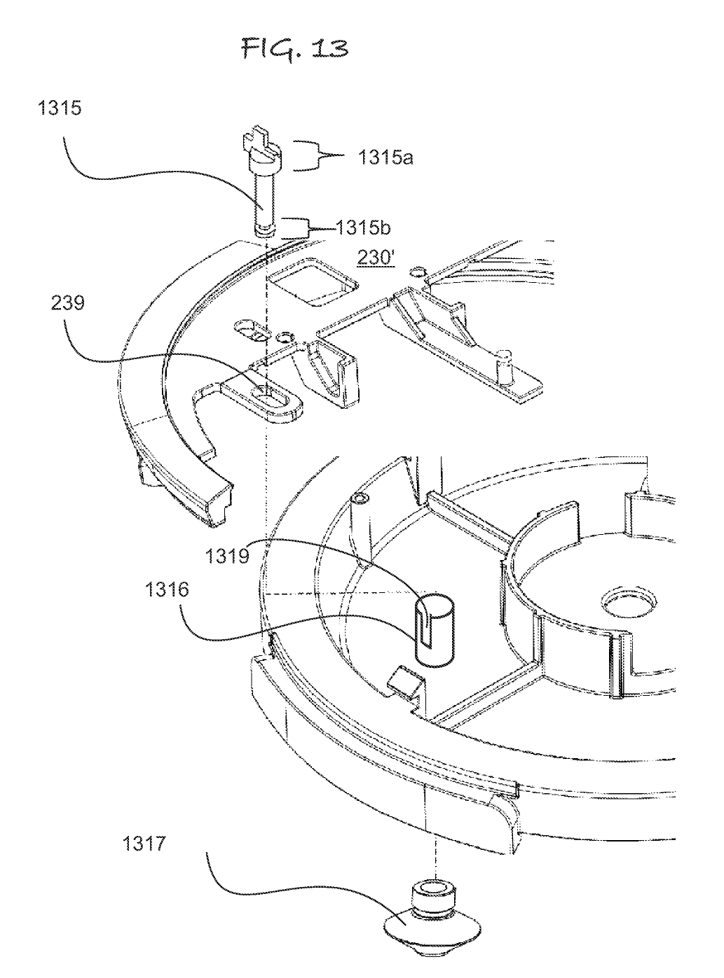

As shown in FIG. 13, the grips outer arms 235 are preferably partially slit to provide an inner portion that act as flexing arm 2351, to provide latching engagement via tonsils formed thereon that engage a corresponding protrusion formed on the upper annular surface of the lid bottom 220.

It is preferable for both grips 230 and 230′ to move in unison. This is accomplished by coupling of the two arms inner arms 234 on opposing sides of each of the grips 230 and 230′, as these portions extends forward at portion 237 via an aperture in formed in the actuator well 248. The end of each of the forward arms 237 has a pin 238 that is receiving in one of the bores 276 on opposing ends of a rocker arm 270 and thus connects both of the grips 230 an 230′ via grips pins 238 on grips 230 and 230′. The rocker arm 270 has a central aperture 272 that is engaged by a downward descending cylinder 245 in the center of lower surface of the actuator 240. The descending pin or cylinder 245 is urged upward by the resilient bellows 260, so the central actuator button 240 is upward as shown in FIG. 10A and 10B.

In an alternative embodiment, the coupled movement of the grips arms 230 and 230′ can urge a vent relief member to seal. In contrast, a rearward movement would urge a the vent relief member to an open position. In one alternative embodiment, forward actuating member 239 terminates in a pin at the end thereof for sealing a bore in the vertical wall 2221 of channel of the vent well 221. This bore would provide a direct or indirect path to an opening in the bottom lid 220, either via the vent well 221 channel or another channel.

FIG. 13-14 illustrates a more preferably embodiment in which a second latching means is operative to prevent the outward movement of the grip 230′ when the vessel 100 is pressured. Grip 230′ is not restrained directly by stopper pin 2215. The second latch means is latching pin 1315 that is urged upward under pressure by a connected locking pin bellows 1317. The locking pin bellows 1317 secures a lower portion 1315b of the lock pin 1315 from the underside of the bottom lid 220. The forward extending arm 239 has an aperture that engages the top portion 1315a of the pin 1315 rising upward from channel 1316 that extends upward from the in the bottom lid 220. The channel 1316 is closed by the bellows 1317, which is connected to the bottom 1315b of the pin 1315, as shown in FIG. 14B, If the vessel 100 is pressurized, the pin 1315 will be in an upper position (broken line in FIG. 14B), securing the latch 239 and preventing outward movement of grips 230 and 230′, thus precluding the removal of the lid 200. An upper portion of the channel 1316 has a slot 1319 for receiving a lateral extending fin 1318 at the top of the pin 1315. The lateral extending fin 1318 that engages the channel slot 1319 to guide the pin 1315 as it moves vertically in response to the bellows 1317 compression and expansion. The bottom of the pin 1315 has a circumferential annular recess that receives a mating extending flange of from an inner bore of the bellows 1317.

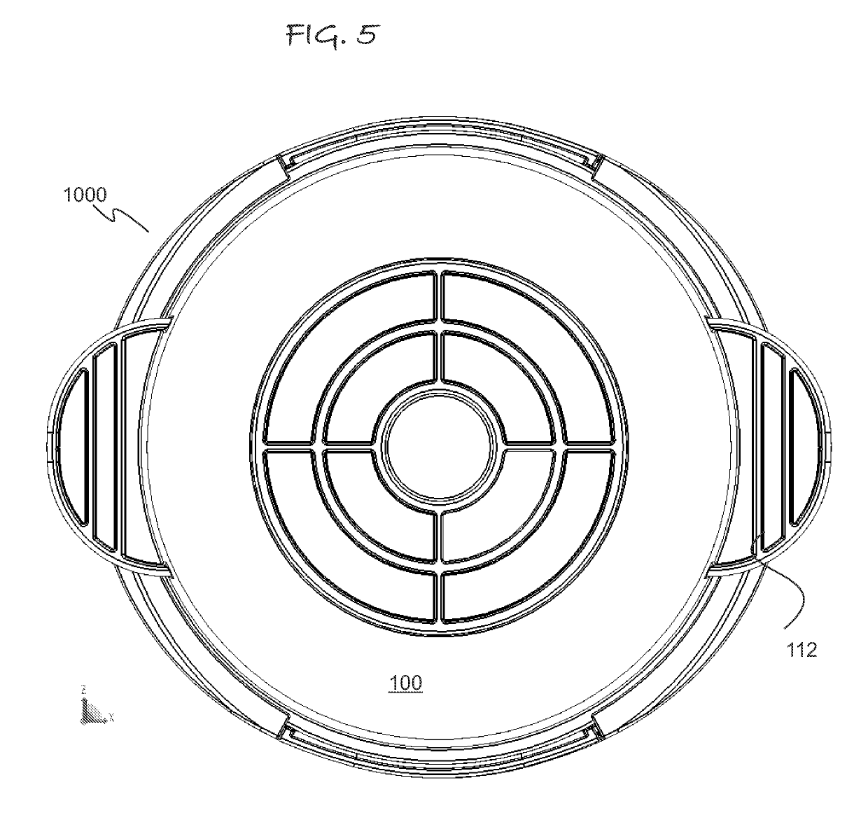

It should be appreciated that as the entire device can be formed of plastic and rubber that are non-conductive, the device is fully compatible with heating food and water therein in a microwave oven. To the extent the lower lid and vessel wall or bottom have ribs to increase the stiffness, the thickness of the walls can be reduced. Preferably, one surface of the lower has radial ribs and the bottom of the vessel has at least one of radial and tangential ribs, that is raised circles on the bottom. The underside of the vessel handles 112 also preferably has ribs, as shown in FIG. 5

The central button 240 provides convenient notice to the user that the vessel 100 is under pressure, and thus should be vented before trying to remove the lid 200. The vessel 100 is conveniently and safely vented by pressing on one side of the vent well cover 212. Thereafter, the central button 240 is pressed again to extend the grips 230 and 230′ so the lid 200 can be removed.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

We claim:

1. A pressure containing chamber, comprising:
a) a vessel having an upper rim with a flange portion,
b) a lid for sealing the vessel,
c) a resilient sealing means disposed between the lid and the upper rim,
d) a pair of arc shaped laterally translating grips that have a lower surface for grasping the flange portion of the vessel to urge the lid in sealed engagement with the vessel by compressing the resilient sealing means,
e) an actuator disposed in the center of the lid that is operative to move to an upper vertical direction position to display a pressurized state of the vessel in which urging the said actuator to a lower vertical laterally displaces the translating grips from the position urging the lid in sealed engagement with the vessel by compressing the resilient sealing means.

2. The pressure containing chamber of claim 1 wherein the actuator is a button disposed in the center of the lid to be flush with an upper surface thereof when the vessel is not pressurized.

3. The pressure containing chamber of claim 1 further comprising a latching means that is operative to lock the grips when the vessel is under pressure.

4. The pressure containing chamber of claim 2 wherein the latching means is a first vent means that remains open until the arc shaped laterally translating grips urge the lid in sealed engagement with the vessel by compressing the resilient sealing means.

5. The pressure containing chamber of claim 4 further comprising a vent well in the lid disposed outside of a vertical channel therein that receives the actuator.

6. The pressure containing chamber of claim 5 wherein the first vent means is disposed in the vent well.

7. The pressure containing chamber of claim 6 further comprising a second vent means that is disposed in the vent well.

8. The pressure containing chamber of claim 7 further comprising a vent well cover that is operative to actuate the second vent means.

9. The pressure containing chamber of claim 8 wherein a vent well cover is actuated on a first end to open the second vent means by toggling from a horizontal orientation to a tilted orientation.

10. The pressure containing chamber of claim 9 wherein the vent well cover comprises one or more vent holes proximal to second end opposite the first end.

11. The pressure containing chamber of claim 5 further comprising a pressure regulating diaphragm in the vent well.

12. The pressure containing chamber of claim 11 further comprising an over pressure relief valve in the vent well that is operative to vent at a pressure beyond the nominal maximum operating pressure of the pressure regulating diaphragm.

13. A pressure containing chamber comprising:
a) a vessel with an upper rim,
b) a lid for sealing the vessel at the rim thereof, and defining an interior volume between an interior of the vessel and a lower surface of the lid, the lid having;
i) a upper portion with a central aperture that accommodates a central actuator and a peripheral aperture that accommodates a secondary actuator, in which the peripheral aperture is outside of the central aperture
ii) a lower portion having an annular lower flange for engaging a gasket, wherein an open cavity is formed between the upper portion and the lower portion,
iii) a channel defined by vertical wall connecting the peripheral aperture with one or more penetration in the lower portion of the lid,
iv) a first valve sealing the one or more penetrations in the lower lid within the channel.
v) wherein said secondary actuator is operative to open said first valve and equalize pressure between the interior volume and the exterior of the vessel.

14. The pressure containing chamber of claim 13 wherein the secondary actuator is a cover of the peripheral aperture.

15. The pressure containing chamber of claim 14 further comprising a first pressure regulator sealing a penetration in the lower lid within the channel.

16. The pressure containing chamber of claim 15 further comprising an over pressure valve sealing a penetration in the lower lid within the channel, where the pressure regulator is operative to regulate pressure to a first pressure level and the over pressure valve is operative to open and equalize pressure between the interior volume and the exterior of the vessel at a second pressure level above the first pressure value.

17. The pressure containing chamber of claim 13 further comprising a cover of the peripheral aperture defines an interior volume of the channel having a second value and the interior volume of the vessel has a first volume in which the first value is more than 0.1% of the second value.

18. The pressure containing chamber of claim 13 further comprising a cover of the peripheral aperture defines an interior volume of the channel having a second value and the interior volume of the vessel has a first volume in which the first value is more than 0.2% of the second value.

19. The pressure containing chamber of claim 13 further comprising a cover of the peripheral aperture defines an interior volume of the channel having a second value and the interior volume of the vessel has a first volume in which the first value is more than 0.5% of the second value.

20. The pressure containing chamber of claim 13 in which the central actuator disposed in the center of the lid that is operative to move to an upper vertical direction position to displaying a pressurized state of the vessel in which urging the said actuator to a lower vertical laterally disengages the lid for lifting from the rim of the vessel.
